(19) United States
(12) Patent Application Publication
(10) Pub. No.: US 2025/0010671 A1
(43) Pub. Date: Jan. 9, 2025

(54) HITCH HOOK

(71) Applicant: James E. Davies, III, Atwater, OH (US)

(72) Inventor: James E. Davies, III, Atwater, OH (US)

(21) Appl. No.: 18/428,374

(22) Filed: Jan. 31, 2024

Related U.S. Application Data
(60) Provisional application No. 63/512,607, filed on Jul. 7, 2023.

(51) Int. Cl. B60D 1/58

(52) U.S. Cl. CPC B60D 1/58

(57) ABSTRACT

Provided in this disclosure is a hitch adapter having a base plate and a latch plate. The base plate includes a plurality of anchor points and first and second semicircular cutouts. The base plate also includes a plurality of connection points disposed radially about a center point. The latch plate includes a latch semicircular cutout and a plurality of connection points—equal to the quantity of base plate connection points and corresponding to the locations of the base plate connection points. The latch plate is disposed atop the base plate.

### I. BACKGROUND

### A. Technical Field

This invention pertains to the field of truck and trailer hitches. More particularly, the invention pertains to the field of hitch adapters for use with 5^{th} wheel ball hitch pins.

### B. Description of Related Art

5^{th} wheel balls, present on truck beds, have been used in a variety of ways, with different adapters, hitches, and attachments. The ball pin allows a user to affix heavy trailers and pull large amounts of weight with their truck, using the ball pin as a connection point.

However, many of these hitches and adapters are specifically designed to fill a particular niche or address a highly specific problem. They are typically not applicable to different situations and are instead narrowly tailored in form and function.

Additionally, current hitch adapters do not provide a desirable quantity and orientation of contact points to afford connection options for users wishing to secure different types of equipment and cargo to their truck beds. For example, when transporting 1 or 2 dirt bike(s), ATV(s), etc. in the bed of a truck, there is no easy, convenient way to secure the back of the vehicle(s). When transporting an extension ladder in the bed of a truck already equipped with a 5^{th} wheel ball hitch, current technologies do not afford a quick and secure latch point. What is needed is a hitch adapter that is broadly applicable to many situations, and which provides the desired connection and securement options for users to secure various equipment and cargo to their truck beds.

The present invention attempts to resolve the forgoing issues by introducing a unique structure and design of hitch adapter that provides a quick, convenient, and secured hook point.

### II. SUMMARY

In accordance with an aspect of the present invention, a hitch adapter, for use with an associated hitch having a proximal end mounted to an associated mode of transport, a distal end, and a stem positioned between the proximal end and the distal end, the hitch adapter including a base plate having at least one anchor point for use in anchoring at least one associated object to the associated mode of transportation, a cavity, a latch plate selectively positionable with respect to the base plate between an open position where the distal end of the hitch passes through the cavity in the base plate and a closed position where the latch plate abuts the stem of the hitch and the distal end of the hitch cannot pass through the cavity in the base plate.

In accordance with another aspect of the present invention, a hitch adapter wherein the base plate further includes a plurality of connection points disposed radially about a center point, on the base plate, and the latch plate further includes a plurality of corresponding connection points for securing the latch plate to the base plate. Fasteners may be disposed within the connection points to secure the latch plate to the base plate. The fasteners may be bolts. The cavity may have a variable opening, wherein the latch plate is pivotably disposed over the variable opening. The latch plate may be selectively pivotable between a position wherein the variable opening is larger than the hitch distal end and a position wherein the opening is smaller than the hitch distal end but larger than the hitch stem.

In accordance with another aspect of the present invention, a hitch adapter wherein the variable opening includes a first semicircular cutout having a first radius, and a second semicircular cutout having a second radius. The second radius may be less than the first radius, and the latch plate may include a latch semicircular cutout having a third radius, wherein the third radius is equal to the second radius.

In accordance with another aspect of the present invention, a hitch adapter wherein the base plate may further include a first anchor point and a second anchor point disposed opposite the first, and the first and second semicircular cutouts may be disposed between the first and second anchor points. The first semicircular cutout may be disposed concentrically with the center point, and the second semicircular cutout at least partially overlaps with the first cutout. The base plate may have a slide connection point, and a pivot connection point may be disposed a circumferential distance from the slide connection point.

In accordance with another aspect of the present invention, a hitch adapter wherein the latch plate may be circular and disposed concentrically with the center point. The latch plate may include a slide connection point and a pivot connection point disposed a circumferential distance from the slide connection point, a slide channel cut circumferentially into the latch plate, and the slide connection point may be disposed along the channel. The latch plate may be configured to pivot about the pivot connection point between the open position and the closed position. While in the open position, the latch plate may leave both the first and second semicircular cutouts uncovered. While in the closed position, the latch plate may cover the first semicircular cutout but leave the second semicircular cutout uncovered. The latch cutout may be disposed concentrically with the second semicircular cutout, when the latch plate is in the closed position.

In accordance with another aspect of the present invention, the latch plate may be retained in the closed position using a bolt. The latch plate may also be retained in the closed position using a latch.

In accordance with another aspect of the present invention, a hitch adapter for use with an associated hitch having a proximal end mounted to an associated mode of transport, a distal end, and a stem positioned between the proximal end and the distal end, the hitch adapter including a circular base plate having at least one anchor point for use in anchoring at least one associated object to the associated mode of transportation, a cavity, a latch plate selectively positionable with respect to the base plate between an open position where the distal end of the hitch passes through the cavity in the base plate and a closed position where the latch plate abuts the stem of the hitch and the distal end of the hitch cannot pass through the cavity in the base plate.

In accordance with another aspect of the present invention, a hitch adapter wherein the base plate further includes a plurality of connection points disposed radially about a center point, on the base plate, and the latch plate further includes a plurality of corresponding connection points for securing the latch plate to the base plate. Fasteners may be disposed within the connection points to secure the latch plate to the base plate. The fasteners may be bolts. The cavity may have a variable opening, wherein the latch plate is pivotably disposed over the variable opening. The latch plate may be selectively pivotable between a position wherein the variable opening is larger than the hitch distal end and a position wherein the opening is smaller than the hitch distal end but larger than the hitch stem.

In accordance with another aspect of the present invention, a hitch adapter wherein the variable opening includes a first semicircular cutout having a first radius, and a second semicircular cutout having a second radius. The second radius may be less than the first radius, and the latch plate may include a latch semicircular cutout having a third radius, wherein the third radius is equal to the second radius.

In accordance with another aspect of the present invention, a hitch adapter wherein the base plate may further include four anchor points disposed equidistantly around the center point, and the first and second semicircular cutouts may be disposed centrally to the anchor points. The first semicircular cutout may be disposed concentrically with the center point, and the second semicircular cutout at least partially overlaps with the first cutout. The base plate may include a slide connection point and a pivot connection point disposed a circumferential distance from the slide connection point.

In accordance with another aspect of the present invention, a hitch adapter wherein the latch plate may be circular and disposed concentrically with the center point. The latch plate may include a slide connection point and a pivot connection point disposed a circumferential distance from the slide connection point, a slide channel cut circumferentially into the latch plate, and the slide connection point may be disposed along the channel. The latch plate may be configured to pivot about the pivot connection point between the open position and the closed position. While in the open position, the latch plate may leave both the first and second semicircular cutouts uncovered. While in the closed position, the latch plate may cover the first semicircular cutout but leave the second semicircular cutout uncovered. The latch cutout may be disposed concentrically with the second semicircular cutout, when the latch plate is in the closed position.

Other benefits and advantages of this invention will become apparent to those skilled in the art to which it pertains upon reading and understanding of the following detailed specification.

### III. BRIEF DESCRIPTION OF THE DRAWINGS

The disclosed hitch adapter may take physical form in certain parts and arrangement of parts, embodiments of which will be described in detail in this specification and illustrated in the accompanying drawings which form a part hereof and wherein:

FIG. 1 is a view of the assembled hitch adapter secured around a hitch wheel ball;

FIG. 2 is a component view of the base plate, top perspective;

FIG. 3 is a component view of the latch plate, top perspective;

FIG. 4 is an alternative angle view of the assembled hitch adapter secured around a hitch wheel ball;

FIG. 5 is a perspective view of an alternative embodiment of the assembled hitch adapter secured around a hitch wheel ball.

### IV. DETAILED DESCRIPTION

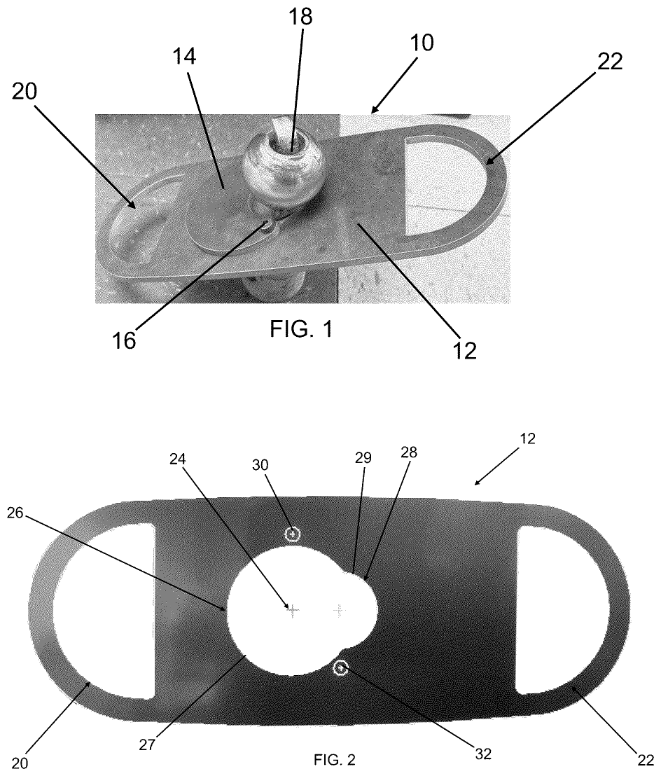

Referring now to the drawings, wherein the showings are for purposes of illustrating embodiments of the invention only and not for purposes of limiting the same, and wherein like reference numerals are understood to refer to like components, FIG. 1 shows a hitch adapter 10 according to some embodiments of the present subject matter. The hitch adapter 10 may be used for cargo, dirt bike, ATV, and other equipment and object tie-downs, utilizing hitches present on some vehicles, including but not limited to trucks, tow boats, and other modes of transport. The hitch adapter 10 may include a base plate 12 and a latch plate 14, and the latch plate 14 may be disposed over the base plate 12.

With reference to FIGS. 2 and 5, the base plate 12 may include a plurality of anchor points 20, 22, first 26 and second 28 semicircular cutouts, and a plurality of connection points 30, 32. Anchor points may be solid sections disposed on the edges of voids in the base plate 12, whereby hooks, ropes, cords, or other securement devices may be affixed. In a particular embodiment, the anchor points 20, 22 can include a first anchor point 20 and a second anchor point 22, which may be disposed opposite each other. In another embodiment, the anchor points 50 may be disposed radially about a center point 24; in such alternative embodiment the center of a ball hitch 18 may also represent the center point 24. The first cutout 26 may have a first radius 27, and the second cutout 28 may have a second radius 29. The second radius 29 may be less than the first radius 27. The connection points 30, 32 can be disposed radially about a center point 24 and in a particular embodiment, may include a slide connection point 30 and a pivot connection point 32. The pivot connection point 32 may be disposed a circumferential distance from the slide connection point 30. The connection points 30, 32 may operate to secure the base 12 and latch 14 plates together and engage a latching operation, as described further below. The base plate 12 may be oblong, circular, or any other shape chosen according to sound engineering judgment.

With reference to FIG. 2, the base plate 12 first 26 and second 28 semicircular cutouts may be disposed between the first 20 and second 22 anchor points. In a particular embodiment, the first semicircular cutout 26 may be disposed concentrically with the center point 24. The second semicircular cutout 28 may at least partially overlap with the first cutout 26.

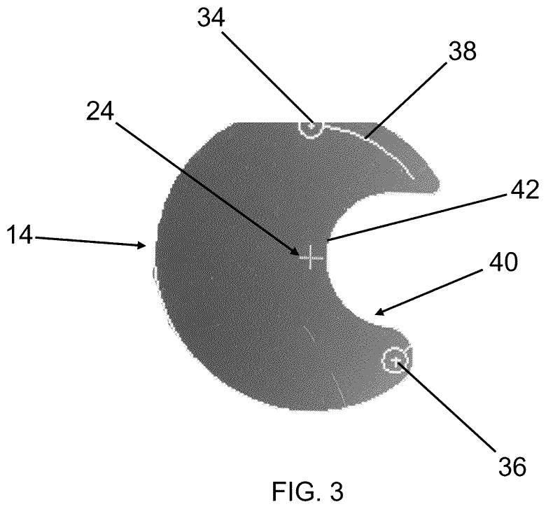

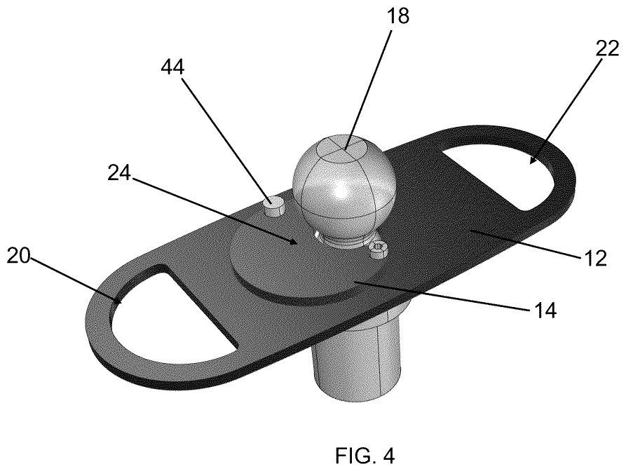

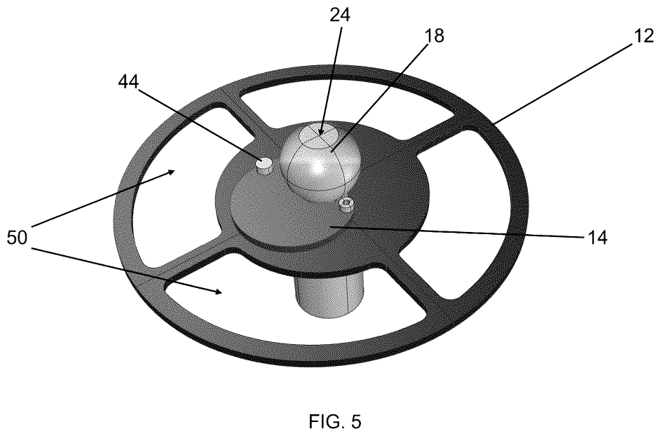

With reference to FIG. 3, the latch plate 14 may include a latch semicircular cutout 40 having a third radius 42, a plurality of connection points 34, 36, and a slide channel 38. The latch cutout 40 third radius 42 may be equal to the second radius 29 of the second cutout 28. The connection points 34, 36 may be equal to the quantity of base plate connection points 30, 32 and correspond to the locations of the base plate connection points 30, 32. In a particular embodiment, the latch plate connection points 34, 36 can be disposed radially about the center point 24. The latch plate 14 may include a slide connection point 34 and a pivot connection point 36 disposed a circumferential distance from the slide connection point 34. The slide channel 38 may be cut circumferentially into the latch plate 14—typically along the edge of the latch plate 14, but it may be cut in any location chosen with sound engineering judgement. The slide connection point 34 may be disposed along the slide channel 38. In a particular embodiment, the latch plate 14 may be circular and disposed concentrically with the center point 24.

With reference to FIG. 5, the base plate 12 may be circular in shape. In a particular embodiment, the circular base plate 12 may have anchor points 50, which may be solid sections disposed on the edges of voids around the perimeter of the circular base plate 12, whereby hooks, ropes, cords, or other securement devices may be affixed, disposed radially about a center point 24. The latch plate 14 may be configured to pivot about pivot connection points between an open position and a closed position. The center of the ball hitch 18 may represent the center point 24.

With reference to FIGS. 1, 2, 3, & 4, the various components of the hitch adapter 10 may function together to engage a latching operation that secures the adapter 10 to a hitch 18. The hitch upon which the hitch adapter is secured may be located on the rear bed of a truck, the back of an aquatic tow vehicle, the underside of a truck, or any other location chosen according to sound engineering judgement. The base plate 12 and latch plate 14 may be secured together at the slide connection points 30, 34 and the pivot connection points 32, 36, using bolts (shown here in a particular embodiment as 16) or any other fastener chosen according to sound engineering judgement. The latch plate 14 may be configured to pivot about the pivot connection points 32, 36 between an open position and a closed position. The latch plate 14 may interact with the base plate 12 to enclose and capture the hitch 18 mounted to the mode of transport. The hitch 18 has a ball and a stem positioned between the hitch's proximal end and distal end, and the hitch adapter 10 open position may allow the ball of the hitch to pass through the cavity in the base plate 12. The hitch adapter 10 can then be lowered over the hitch 18 and the latch plate 14 positioned into a closed position where the latch plate 12 encloses the stem of the hitch. While in this closed position, the latch plate 14 abuts the stem of the hitch and the ball of the hitch is mechanically blocked by the latch plate 14 and cannot pass through the cavity in the base plate 12. Once the hitch adapter 10 is installed, ropes, chains, bungee cords, ratcheting or winch straps, or any tie-down equipment chosen according to sound engineering judgment, may be knotted, tied, clamped, hooked, or otherwise secured to the anchor points 20, 22, 50 of the hitch adapter 10. By looping, tying, or otherwise securing the tie-down equipment to cargo, dirt bikes, ATVs, and other equipment and objects, the equipment or object may be effectively secured to the hitch adapter 10—which itself may be secured to the hitch 18 of the associated mode of transport in the manner described above.

In a particular embodiment, beginning in the open position, and while in the open position, the latch plate 14 leaves both the first 24 and second 28 semicircular cutouts uncovered. While in the open position, a ball hitch may be inserted through the first semicircular cutout 24, which cutout first radius 27 is large enough to encompass the ball hitch 18. After passing the ball hitch through the first cutout 24, the user swings the latch plate 14 around the stem of the ball hitch 18. While in the closed position, the latch plate 14 covers the first semicircular cutout 24 but leaves the second semicircular cutout 28 uncovered. The second cutout 28 second radius 29 is not sufficiently large to allow the head of the ball hitch 18 to pass through, thus capturing the stem of the ball hitch 18 and latching the ball hitch 18 and adapter 10 together. The latch cutout 40 may be disposed concentrically with the second semicircular cutout 28 when the latch plate 14 is in the closed position. The latch plate 14 may then be secured with a latch pin 44. The latch plate 14 also may be retained in the closed position using a bolt, latch or other binding mechanism chosen according to sound engineering judgement.

Having thus described the invention, it is now claimed:

What is claimed:

1. A hitch adapter, for use with an associated hitch having a proximal end mounted to an associated mode of transport, a distal end, and a stem positioned between the proximal end and the distal end, the hitch adapter comprising:
a base plate having:
at least one anchor point for use in anchoring at least one associated object to the associated mode of transportation;
a cavity;
a latch plate selectively positionable with respect to the base plate between:
an open position where the distal end of the hitch passes through the cavity in the base plate; and
a closed position where the latch plate abuts the stem of the hitch and the distal end of the hitch cannot pass through the cavity in the base plate.

2. The hitch adapter of claim 1 wherein:
the base plate further comprises a plurality of connection points disposed radially about a center point, on the base plate;
the latch plate further comprises a plurality of corresponding connection points for securing the latch plate to the base plate; and
fasteners disposed within the connection points to secure the latch plate to the base plate.

3. The hitch adapter of claim 2 wherein the fasteners are bolts.

4. The hitch adapter of claim 2 wherein:
the cavity has a variable opening;
wherein the latch plate is pivotably disposed over the variable opening; and
wherein the latch plate is selectively pivotable between a position wherein the variable opening is larger than the hitch distal end and a position wherein the opening is smaller than the hitch distal end but larger than the hitch stem.

5. The hitch adapter of claim 4, further comprising:
the variable opening comprising:
a first semicircular cutout having a first radius, and a second semicircular cutout having a second radius;
wherein the second radius is less than the first radius;
the latch plate comprising:
a latch semicircular cutout having a third radius; and
wherein the third radius is equal to the second radius.

6. The hitch adapter of claim 5, the base plate further comprising:
a first anchor point and a second anchor point disposed opposite the first; and
wherein the first and second semicircular cutouts are disposed between the first and second anchor points;
wherein the first semicircular cutout is disposed concentrically with the center point, and the second semicircular cutout at least partially overlaps with the first cutout; and
a slide connection point, and a pivot connection point disposed a circumferential distance from the slide connection point.

7. The hitch adapter of claim 5, the latch plate further comprising:
wherein the latch plate is circular and disposed concentrically with the center point;
a slide connection point and a pivot connection point disposed a circumferential distance from the slide connection point;
a slide channel cut circumferentially into the latch plate;
wherein the slide connection point is disposed along the channel;
the latch plate is configured to pivot about the pivot connection point between the open position and the closed position;
while in the open position, the latch plate leaves both the first and second semicircular cutouts uncovered;
while in the closed position, the latch plate covers the first semicircular cutout but leaves the second semicircular cutout uncovered; and
the latch cutout is disposed concentrically with the second semicircular cutout, when the latch plate is in the closed position.

8. The hitch adapter of claim 7, wherein the latch plate is retained in the closed position using a bolt.

9. The hitch adapter of claim 7, wherein the latch plate is retained in the closed position using a latch.

10. A hitch adapter, for use with an associated hitch having a proximal end mounted to an associated mode of transport, a distal end, and a stem positioned between the proximal end and the distal end, the hitch adapter comprising:
a circular base plate having:
at least one anchor point for use in anchoring at least one associated object to the associated mode of transportation;
a cavity;
a latch plate selectively positionable with respect to the base plate between:
an open position where the distal end of the hitch passes through the cavity in the base plate; and
a closed position where latch plate abuts the stem of the hitch and the distal end of the hitch cannot pass through the cavity in the base plate.

11. The hitch adapter of claim 10 wherein:
the base plate further comprises a plurality of connection points disposed radially about a center point, on the base plate;
the latch plate further comprises a plurality of corresponding connection points for securing the latch plate to the base plate; and
fasteners disposed within the connection points to secure the latch plate to the base plate.

12. The hitch adapter of claim 11 wherein the fasteners are bolts.

13. The hitch adapter of claim 11 wherein:
the cavity has a variable opening;
wherein the latch plate is pivotably disposed over the variable opening; and
wherein the latch plate is selectively pivotable between a position wherein the variable opening is larger than the hitch distal end and a position wherein the opening is smaller than the hitch distal end but larger than the hitch stem.

14. The hitch adapter of claim 13, further comprising:
the variable opening comprising:
a first semicircular cutout having a first radius, and a second semicircular cutout having a second radius;
wherein the second radius is less than the first radius;
the latch plate comprising:
a latch semicircular cutout having a third radius; and
wherein the third radius is equal to the second radius.

15. The hitch adapter of claim 14, the base plate further comprising:
four anchor points disposed equidistantly around the center point; and
wherein the first and second semicircular cutouts are disposed centrally to the anchor points;
wherein the first semicircular cutout is disposed concentrically with the center point, and the second semicircular cutout at least partially overlaps with the first cutout; and
a slide connection point, and a pivot connection point disposed a circumferential distance from the slide connection point.

16. The hitch adapter of claim 14, the latch plate further comprising:
wherein the latch plate is circular and disposed adjacent to the center point;
a slide connection point and a pivot connection point disposed a circumferential distance from the slide connection point;
a slide channel cut circumferentially into the latch plate;
wherein the slide connection point is disposed along the channel;
the latch plate is configured to pivot about the pivot connection point between the open position and the closed position;
while in the open position, the latch plate leaves both the first and second semicircular cutouts uncovered;
while in the closed position, the latch plate covers the first semicircular cutout but leaves the second semicircular cutout uncovered; and
the latch cutout is disposed concentrically with the second semicircular cutout, when the latch plate is in the closed position.

17. The hitch adapter of claim 16, wherein the latch plate is retained in the closed position using a bolt.

18. The hitch adapter of claim 16, wherein the latch plate is retained in the closed position using a latch.

19. A hitch adapter, for use with an associated hitch having a proximal end mounted to an associated mode of transport, a distal end, and a stem positioned between the proximal end and the distal end, the hitch adapter comprising:
a base plate having:
at least one anchor point for use in anchoring at least one associated object to the associated mode of transport;
a cavity;
a latch plate selectively positionable with respect to the base plate between:
an open position where the distal end of the hitch passes through the cavity in the base plate;
a closed position where latch plate abuts the stem of the hitch and the distal end of the hitch cannot pass through the cavity in the base plate;
wherein the base plate further comprises a plurality of connection points disposed radially about a center point, on the base plate;
the latch plate further comprises a plurality of corresponding connection points for securing the latch plate to the base plate;
bolts disposed within the connection points to secure the latch plate to the base plate;
wherein the cavity has a variable opening;
the latch plate:
wherein the latch plate is pivotably disposed over the variable opening;
wherein the latch plate is selectively pivotable between a position wherein the variable opening is larger than the hitch distal end and a position wherein the opening is smaller than the hitch distal end but larger than the hitch stem;
the variable opening comprising:
a first semicircular cutout having a first radius, and a second semicircular cutout having a second radius;
wherein the second radius is less than the first radius;
the latch plate having:
a latch semicircular cutout having a third radius; and
wherein the third radius is equal to the second radius.
the base plate further comprising:
a first anchor point and a second anchor point disposed opposite the first; and
wherein the first and second semicircular cutouts are disposed between the first and second anchor points;
wherein the first semicircular cutout is disposed concentrically with the center point, and the second semicircular cutout at least partially overlaps with the first cutout;
a slide connection point, and a pivot connection point disposed a circumferential distance from the slide connection point;
wherein the latch plate is circular and disposed concentrically with the center point;
a slide connection point and a pivot connection point disposed a circumferential distance from the slide connection point;
a slide channel cut circumferentially into the latch plate;
wherein the slide connection point is disposed along the channel;
the latch plate is configured to pivot about the pivot connection point between the open position and the closed position;
while in the open position, the latch plate leaves both the first and second semicircular cutouts uncovered;
while in the closed position, the latch plate covers the first semicircular cutout but leaves the second semicircular cutout uncovered; and
the latch cutout is disposed concentrically with the second semicircular cutout, when the latch plate is in the closed position.

20. The hitch adapter of claim 19, wherein the latch plate is retained in the closed position using a bolt.
